(19) United States
(12) Patent Application Publication
(10) Pub. No.: US 2015/0203093 A1
(43) Pub. Date: Jul. 23, 2015

(54) SYSTEM AND METHOD FOR DETERMINING VEHICLE POWER GENERATION COSTS

(71) Applicant: FORD GLOBAL TECHNOLOGIES, LLC, Dearborn, MI (US)

(72) Inventors: Robert WRIGHT, Royal Oak, MI (US); Marvin Paul Kraska, Dearborn, MI (US)

(73) Assignee: FORD GLOBAL TECHNOLOGIES, LLC, Dearborn, MI (US)

(21) Appl. No.: 14/160,916

(22) Filed: Jan. 22, 2014

(51) Int. Cl. B60W 20/00

(52) U.S. Cl. CPC B60W 20/10

(57) ABSTRACT

A method according to an exemplary aspect of the present disclosure includes controlling a vehicle in a Power Generation mode to supply power to equipment separate from the vehicle. The controlling step includes estimating a cost of operating the vehicle in the Power Generation mode.

### TECHNICAL FIELD

Noon This disclosure relates to an electrified vehicle, and more particularly, but not exclusively, to a system and method for determining costs associated with operating an electrified vehicle in a Power Generation mode.

### BACKGROUND

Electrified vehicles, such as hybrid electric vehicles (HEV's), plug-in hybrid electric vehicles (PHEV's), battery electric vehicles (BEV's), or fuel cell vehicles, differ from conventional motor vehicles in that they are powered by one or more electric machines (i.e., electric motors/generators) instead of or in addition to an engine. In other words, electrified vehicles may have more than one power source that can be used either individually or together to propel the vehicle.

Some electrified vehicles enable a driver to manually manage the vehicle's energy usage. For example, the electrified vehicle may be operated in electric vehicle (EV) mode where the electric machine powers the vehicle without assistance from the engine, or may be operated in hybrid (HEV) mode in which the engine is used in combination with the electric machine to power the vehicle. As use of electrified vehicles becomes more commonplace, additional energy management options may be desirable.

### SUMMARY

A method according to an exemplary aspect of the present disclosure includes controlling a vehicle in a Power Generation mode to supply power to equipment separate from the vehicle. The controlling step includes estimating a cost of operating the vehicle in the Power Generation mode.

In a further non-limiting embodiment of the foregoing method, the vehicle is a hybrid electric vehicle (HEV).

In a further non-limiting embodiment of either of the foregoing methods, the controlling step is only performed if the vehicle is in park.

In a further non-limiting embodiment of any of the foregoing methods, the controlling step includes at least controlling an engine and an electric machine to generate the power supplied during the Power Generation mode.

In a further non-limiting embodiment of any of the foregoing methods, the method includes entering at least one billing rate associated with operating the vehicle.

In a further non-limiting embodiment of any of the foregoing methods, the cost is estimated using the at least one billing rate.

In a further non-limiting embodiment of any of the foregoing methods, the method includes entering energy usage limits for limiting a total amount of energy consumed during the Power Generation mode.

In a further non-limiting embodiment of any of the foregoing methods, the method includes performing a series of periodic system checks to monitor a total energy usage of the vehicle during the GEN mode.

In a further non-limiting embodiment of any of the foregoing methods, the method includes shutting down the Power Generation mode in response to at least one of the following occurring: exceeding a fuel consumption limit; exceeding an energy consumption limit; or exceeding a time usage limit

In a further non-limiting embodiment of any of the foregoing methods, the method includes displaying the costs associated with operating the vehicle in the Power Generation mode to an operator.

A vehicle control method according to another exemplary aspect of the present disclosure includes operating a vehicle in a Power Generation mode, supplying power to a power point of the vehicle during the Power Generation mode, and estimating a cost associated with operating the vehicle in the Power Generation mode.

In a further non-limiting embodiment of the foregoing method, the method includes periodically measuring fuel consumption, energy consumption, and time usage during the step of operating.

In a further non-limiting embodiment of either of the foregoing methods, the step of estimating includes at least one of the following: multiplying a total consumption by a fuel billing rate, multiplying total energy consumption by an energy billing rate, or multiplying total run time by a time billing rate.

In a further non-limiting embodiment of any of the foregoing methods, the method includes displaying the cost information to an operator of the vehicle.

A system according to an exemplary aspect of the present disclosure includes a driver interface that provides selection of various vehicle operating modes including a Power Generation mode, and a control unit in communication with the driver interface and configured to estimate a cost associated with operating the vehicle in the Power Generation mode.

In a further non-limiting embodiment of the foregoing system, the driver interface includes a mode selector having a Power Generation mode button for selecting the Power Generation mode.

In a further non-limiting embodiment of either of the foregoing systems, a sensor is configured to measure voltage and current information associated with powering the vehicle in the Power Generation mode.

In a further non-limiting embodiment of any of the foregoing systems, a converter is configured to convert DC power from an electric machine to AC power supplied to a power point located on the vehicle.

In a further non-limiting embodiment of any of the foregoing systems, the power point includes at least one power outlet.

In a further non-limiting embodiment of any of the foregoing systems, the control unit is operable to communicate control signals to each of an engine, a battery and an electric machine for operating the vehicle in the Power Generation mode.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a vehicle energy management system that can be used to operate an electrified vehicle in a Power Generation mode.

FIG. 3 illustrates a driver interface of a vehicle energy management system.

FIG. 4 illustrates a power point of vehicle energy management system.

FIG. 5 illustrates a vehicle control strategy for determining costs associated with operating an electrified vehicle in a Power Generation mode.

### DETAILED DESCRIPTION

This disclosure relates to an energy management system and method for controlling the energy usage of an electrified vehicle. The vehicle may be operated in a Power Generation mode in which power is supplied to operate non-vehicle equipment. The costs associated with operating the electrified vehicle in Power Generation mode may also be estimated and reported to a vehicle driver, operator or owner. The estimated costs may be based on total fuel consumption, electrical energy consumption, and time usage. These and other features are discussed in greater detail herein.

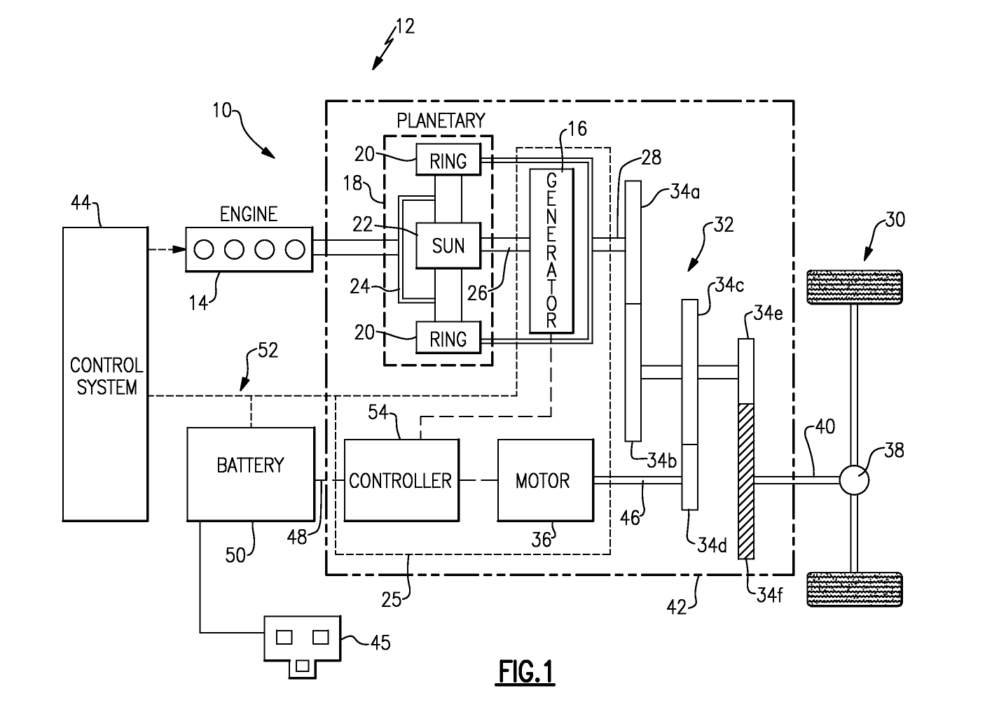

FIG. 1 schematically illustrates a powertrain 10 for an electrified vehicle 12 that is capable of implementing the energy management system and methods of this disclosure. It should be understood that the concepts described herein are not limited to HEV' s and could extend to other electrified vehicles, including but not limited to, PHEV's, BEV' s, and fuel cell vehicles.

In one embodiment, the powertrain 10 is a power split system that employs a first drive system that includes a combination of an engine 14 and a generator 16 (i.e., a first electric machine) and a second drive system that includes at least a motor 36 (i.e., a second electric machine), the generator 16 and a battery 50. For example, the motor 36, the generator 16 and the battery 50 may make up an electric drive system 25 of the powertrain 10. The first and second drive systems generate torque to drive one or more sets of vehicle drive wheels 30 of the electrified vehicle 12.

The engine 14, such as an internal combustion engine, and the generator 16 may be connected through a power transfer unit 18. In one non-limiting embodiment, the power transfer unit 18 is a planetary gear set. Of course, other types of power transfer units, including other gear sets and transmissions, may be used to connect the engine 14 to the generator 16. The power transfer unit 18 may include a ring gear 20, a sun gear 22 and a carrier assembly 24. The generator 16 is driven by the power transfer unit 18 when acting as a generator to convert kinetic energy to electrical energy. The generator 16 can alternatively function as a motor to convert electrical energy into kinetic energy, thereby outputting torque to a shaft 26 connected to the carrier assembly 24 of the power transfer unit 18. Because the generator 16 is operatively connected to the engine 14, the speed of the engine 14 can be controlled by the generator 16.

The ring gear 20 of the power transfer unit 18 may be connected to a shaft 28 that is connected to vehicle drive wheels 30 through a second power transfer unit 32. The second power transfer unit 32 may include a gear set having a plurality of gears 34A, 34B, 34C, 34D, 34E, and 34F. Other power transfer units may also be suitable. The gears 34A-34F transfer torque from the engine 14 to a differential 38 to provide traction to the vehicle drive wheels 30. The differential 38 may include a plurality of gears that enable the transfer of torque to the vehicle drive wheels 30. The second power transfer unit 32 is mechanically coupled to an axle 40 through the differential 38 to distribute torque to the vehicle drive wheels 30.

The motor 36 can also be employed to drive the vehicle drive wheels 30 by outputting torque to a shaft 46 that is also connected to the second power transfer unit 32. In one embodiment, the motor 36 and the generator 16 are part of a regenerative braking system in which both the motor 36 and the generator 16 can be employed as motors to output torque. For example, the motor 36 and the generator 16 can each output electrical power to a high voltage bus 48 and the battery 50.

The battery 50 may be a high voltage battery that is capable of outputting electrical power to operate the motor 36 and the generator 16. Other types of energy storage devices and/or output devices can also be incorporated for use with the electrified vehicle 12. In a non-limiting PHEV embodiment of the electrified vehicle 12, the battery 50 may be recharged or partially recharged using a charging adapter 45 that is connected to a charging station powered by an external power source, such as an electrical grid, a solar panel, or the like.

The motor 36, the generator 16, the power transfer unit 18, and the power transfer unit 32 may generally be referred to as a transaxle 42, or transmission, of the electrified vehicle 12. Thus, when a driver selects a particular shift position, the transaxle 42 is appropriately controlled to provide the corresponding gear for advancing the electrified vehicle 12 by providing traction to the vehicle drive wheels 30.

The powertrain 10 may additionally include a control system 44 for monitoring and/or controlling various aspects of the electrified vehicle 12. For example, the control system 44 may communicate with the electric drive system 25, the power transfer units 18, 32 or other components to monitor and/or control the electrified vehicle 12. The control system 44 includes electronics and/or software to perform the necessary control functions for operating the electrified vehicle 12. In one embodiment, the control system 44 is a combination vehicle system controller and powertrain control module (VSC/PCM). Although it is shown as a single hardware device, the control system 44 may include multiple controllers in the form of multiple hardware devices, or multiple software controllers within one or more hardware devices.

A controller area network (CAN) 52 allows the control system 44 to communicate with the transaxle 42. For example, the control system 44 may receive signals from the transaxle 42 to indicate whether a transition between shift positions is occurring. The control system 44 could also communicate with a battery control module of the battery 50, or other control devices.

Additionally, the electric drive system 25 may include one or more controllers 54, such as an inverter system controller (ISC). The controller 54 is configured to control specific components within the transaxle 42, such as the generator 16 and/or the motor 36, such as for supporting bidirectional power flow. In one embodiment, the controller 54 is an inverter system controller combined with a variable voltage converter (ISC/VVC).

In one non-limiting embodiment, the electrified vehicle 12 has two basic operating modes. The electrified vehicle 12 may operate in an Electric Vehicle (EV) mode where the motor 36 is used (generally without assistance from the engine 14) for vehicle propulsion, depleting the battery 50 state of charge up to its maximum allowable discharging rate under certain driving patterns/cycles. The EV mode is an example of a charge depleting mode of operation for the electrified vehicle 12. During EV mode, the state of charge of the battery 50 may increase in some circumstances, for example due to a period of regenerative braking. The engine 14 is generally not permitted to operate under a default EV mode, but may need to be operated based on a vehicle system state or as permitted by the operator.

The electrified vehicle 12 may additionally be operated in a Hybrid (HEV) mode in which the engine 14 and the motor 36 are both used for vehicle propulsion. The HEV mode is an example of a charge sustaining mode of operation for the electrified vehicle 12. During the HEV mode, the electrified vehicle 12 may reduce the motor 36 propulsion usage to be able to maintain the state of charge of the battery 50 at a constant or approximately constant level by increasing the engine 14 propulsion usage.

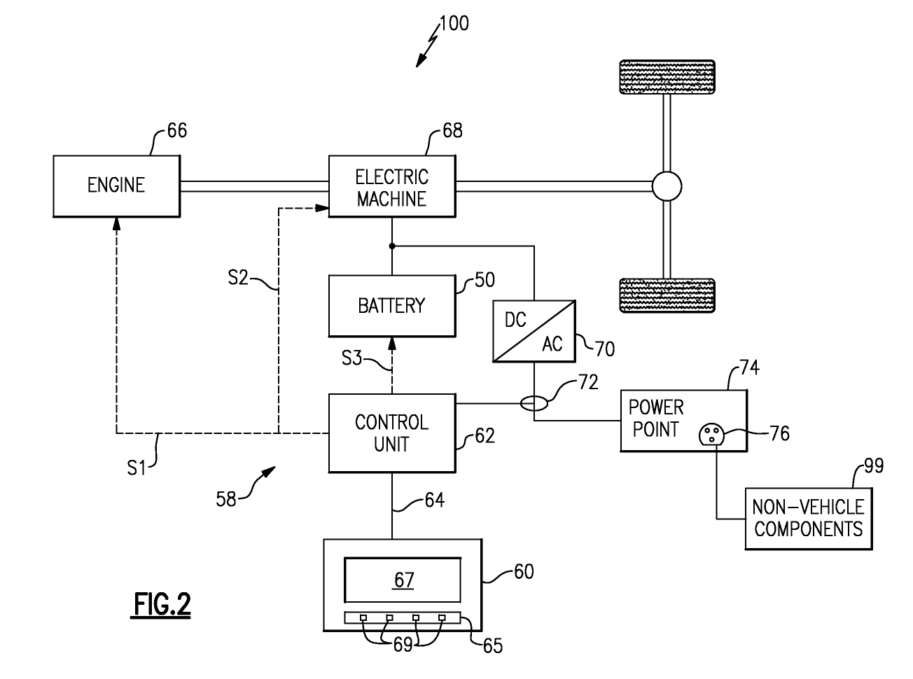

FIG. 2 illustrates a vehicle energy management system 58 that can be used to control a vehicle 100. The vehicle 100 may be an electrified vehicle similar to that shown in FIG. 1. In one embodiment, the vehicle energy management system 58 is employed to control operation of HEV's, although any electrified vehicle may be controlled using the vehicle energy management system 58.

The vehicle 100 includes an engine 66 and an electric machine 68. Although not shown, the engine 66 may be mechanically disconnected from the electric machine 68, such as during EV mode, via a disconnect clutch such that the vehicle 100 is propelled solely by the electric machine 68. Alternatively, in a HEV mode, both the engine 66 and electric machine 68 are employed to propel the vehicle 100. Although only a single electric machine 68 is shown, the vehicle 100 could include multiple electric machines within the scope of this disclosure.

In addition to the EV and HEV operating modes described above, the vehicle energy management system 58 permits operation of the vehicle 100 in a Power Generation (GEN) mode. In the GEN mode, the engine 66 and/or the electric machine 68 generate power for use by the driver/operator for purposes other than propelling the vehicle 100. For example, electrical power may be supplied for powering various non-vehicle equipment 99 (shown schematically) by operating the vehicle 100 in the GEN mode. In one non-limiting embodiment, the non-vehicle equipment 99 could include various tools that a contractor utilizes at a work site, such as saws, drills, or any other powered equipment. Other equipment may also be powered by the vehicle energy management system 58 within the scope of this disclosure.

The vehicle energy management system 58 includes a driver interface 60 and a control unit 62 in electrical communication with the driver interface 60. The driver interface 60 may include a user input 65 and a display 67, shown schematically in this embodiment. The user input 65 may include a touch screen and/or a series of tactile buttons 69 for entering information. The display 67 may include a touch screen and/or a series of gauges for displaying information to the driver.

Using the driver interface 60, the driver or another operator may control the vehicle 100 in GEN mode. The driver interface 60 is generally located inside the vehicle 100, such as within the in-dash entertainment center of the vehicle passenger cabin. The information input into the driver interface 60 by the driver may be communicated to the control unit 62 over electrical connection 64.

The control unit 62 may be part of the control system 44 (see FIG. 1), may be part of a powertrain or transmission control system, or could be a standalone unit in communication with one or more controllers, including but not limited to an engine control module, an electric motor control module, a transmission control module and/or a battery control module. The control unit 62 may communicate with other controllers, modules and/or components over the CAN 52, in one embodiment.

The vehicle energy management system 58 may employ or more algorithms programmed into the control unit 62 in order to control the vehicle 100 in GEN mode and to calculate the costs associated with operating the vehicle 100 in GEN mode. In one embodiment, the control unit 62 can communicate control signals S1 to the engine 66, control signals S2 to the electric machine 68, and control signals S3 to the battery 50 for scheduling and controlling operation of the vehicle 100 in GEN mode and for calculating the costs associated with such power generation.

The vehicle energy management system 58 may additionally include a converter 70, a sensor 72 and a power point 74. The converter 70 converts DC power from the electric machine 68 to AC power that is supplied to the power point 74. The sensor 72 measures voltage and current information of the power communicated to the power point 74 and communicates this information to the control unit 62. This voltage and current information is utilized by the control unit 62 to determine an amount of energy usage, as is further discussed below.

The power point 74 may include one or more power outlets 76. The operator of the vehicle 100 may plug any tools or other non-vehicle equipment 99 into the power outlets 76 in order to power these tools using energy provided by the vehicle 100 during GEN mode.

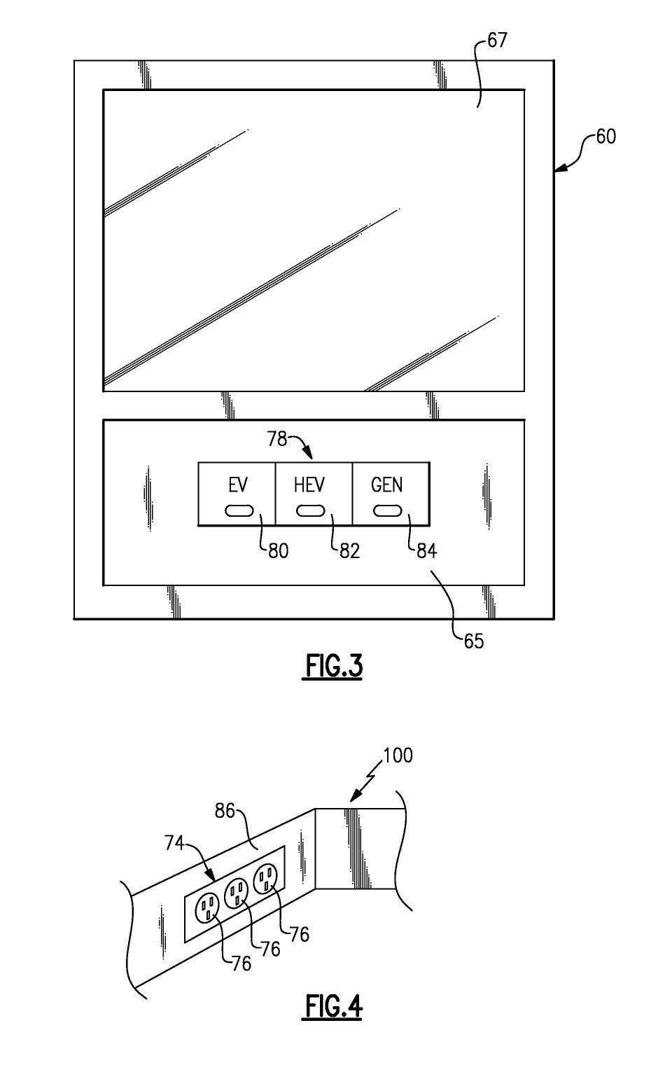

FIG. 3 illustrates one non-limiting embodiment of an exemplary driver interface 60 of a vehicle energy management system 58. The driver interface 60 may include a user input 65 and a display 67. The user input 65 may include various actuators, selectors, switches or the like for inputting driver preferences for managing the energy usage of an electrified vehicle.

In one embodiment, the user input 65 of the driver interface 60 includes a mode selector 78 that allows the driver/operator to select an operating mode preference for controlling and operating the vehicle. The mode selector 78 may include an EV mode button 80 for selecting EV mode, a HEV mode button 82 for selecting HEV mode, and a GEN mode button 84 for selecting GEN mode. Of course, these are intended as non-limiting embodiments of possible energy management modes. It should additionally be understood that the user interface 60 could include other features and functions within the scope of this disclosure.

FIG. 4 illustrates one non-limiting embodiment of a power point 74 of the vehicle energy management system 58. The power point 74 may be mounted to an exposed wall 86 of a vehicle 100. The exposed wall 86 can be located anywhere on the vehicle 100, including but not limited to within a trunk, cargo area, cargo bed, etc. The exposed wall 86 is generally positioned at an easily accessible location of the vehicle 100. Although only a single power point 74 is shown in FIG. 4, it should be understood that the vehicle 100 could be equipped with multiple power points.

The power point 74 includes power outlets 76. The power outlets 76 are ports for connecting and powering equipment that is separate from that located on the vehicle 100. In one non-limiting embodiment, the power outlets 76 supply 120/240 volt AC power at 50/60 Hz to equipment plugged into the power outlets 76.

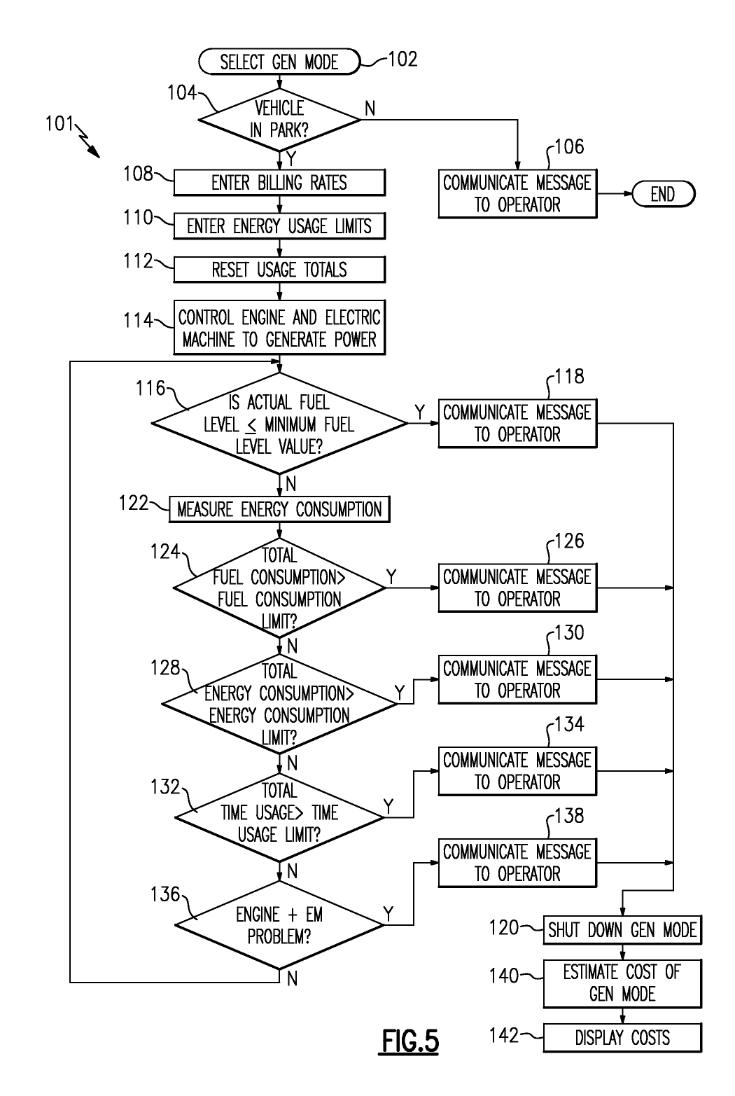

FIG. 5, with continued reference to FIGS. 1-4, schematically illustrates an energy management control strategy 101 for controlling a vehicle 100 using the vehicle energy management system 58. In this embodiment, the control strategy 101 is configured for controlling the vehicle 100 in GEN mode and for estimating the costs associated with operating the vehicle 100 in GEN mode. However, other control strategies may also be implemented and executed by the vehicle 100 within the scope of this disclosure.

The control strategy 101 begins at block 102 in response to a selection of GEN mode. For example, the GEN mode may be selected on the driver interface 60 by actuating the GEN mode button 84 (see FIG. 3).

Next, at block 104, the control unit 62 of the vehicle energy management system 58 confirms whether or not the vehicle 100 is in park. In one embodiment, the vehicle 100 can operate in GEN mode only if the vehicle 100 is in park. If it is determined that the vehicle 100 is not in park, a message can be communicated to the driver interface 60 and displayed on the display 67 at block 106 to instruct the driver/operator of the current unavailability of GEN mode. For example, the message could read “GEN MODE ONLY AVAILABLE WHILE PARKED” or some other similar message.

If the vehicle is in park, the control strategy 101 may proceed to block 108. At block 108, the vehicle driver/operator may enter billing rates associated with energy usage of the vehicle 100. For example, in one non-limiting embodiment, billing rates for fuel consumption (by the engine 66), Watt-hours of energy consumption (by the electric machine 68), and time usage of the vehicle (i.e., wear-and-tear, depreciation, etc.) may be entered. These billing rates are entered in unit of Dollars, or some other monetary unit (e.g., cost in dollars per gallon of gas, etc.). The billing rates may be entered using the user input 65 of the driver interface 60, in one non-limiting embodiment. These billing rates would either be known or readily available to a driver/operator of the vehicle 100.

The driver/operator may additionally enter energy usage limits, as shown at block 110. The energy usage limits are limits the driver/operator wishes to impose on the amount of energy that is expended during the GEN mode. For example, the driver/operator may set limits on the total amounts of fuel consumption, energy consumption, and time usage of operating the vehicle in GEN mode. In another embodiment, the driver/operator may select a minimum fuel level value, which once reached, will trigger the control unit 62 to shut down GEN mode. These are intended as non-limiting examples of the types of energy usage limits that may be set by the driver/operator.

If necessary, at block 112, totals of previous GEN mode energy usage values and/or costs may be reset, cleared or zeroed out using the driver interface 60. Alternatively, these values may be automatically cleared at Key-Off or in response to some other event.

The engine 66 and electric machine 68 are controlled to generate power at block 114. Electrical power may be supplied to the power point 74 (see FIGS. 2 and 4) for powering various non-vehicle equipment 99 by operating the vehicle 100 in the GEN mode. The driver/operator may plug the non-vehicle equipment 99 into the power outlets 76 of the power point 74 as desired in order to supply power to this equipment.

Beginning with block 116, the control strategy 101 may undertake a series of periodic system checks for monitoring the energy usage of the vehicle 100 during the GEN mode. For example, the control unit 62 may compare an actual fuel level of the engine 66 to the minimum fuel level value set at block 110. If the actual fuel level is less than or equal to the minimum fuel level value set at block 110, the control strategy 101 proceeds to block 118 and communicates a “MINIMUM FUEL LEVEL REACHED” message, or some similar message, to the driver interface 60. The GEN mode is then shut down at block 120.

Alternatively, if the minimum fuel level value has not been reached, the control strategy 101 may proceed to block 122 by measuring total energy consumption of the vehicle 100 during GEN mode. For example, the control unit 62 may measure total fuel consumption by the engine 66, total energy consumption by the electric machine 68, and elapsed time that has occurred since GEN mode was selected at block 102. In one non-limiting embodiment, the measurement of the total energy consumption by the electric machine 68 is based on voltage and current readings of the sensor 72 (see FIG. 2).

Next, at block 124, the total fuel consumption that has occurred to that point during GEN mode is compared to the fuel consumption limit established at block 110. If the total fuel consumption exceeds the set limit, a “FUEL LIMIT REACHED” message is communicated at block 126 and the GEN mode is shut down at block 120.

If the fuel consumption limit has not yet been reached, the control strategy 101 proceeds to block 128 where the total energy consumption (in Watt-hours of energy output) is compared to the energy consumption limit set at block 110. A “W-H LIMIT REACHED” message, or some other similar message, is communicated at block 130 and the GEN mode is shut down at block 120 where the total energy consumption limit has been exceeded.

If the energy consumption limit has not yet been reached, the control strategy 101 proceeds to block 132 where the total time usage is compared to the time usage limit previously set at block 112. If the time usage limit has been exceeded, a “RUN TIME LIMIT REACHED” message is communicated at block 134 and the GEN mode is then shut down at block 120.

The control strategy 101 may also check whether any engine 66 or electric machine 68 errors have occurred during operation of the vehicle 100 in GEN mode at block 136. If so, a “CHECK ENGINE” message may be communicated at block 138. If no errors are detected and no limits have been exceeded, the control strategy 101 returns to block 116 where the periodic system checks can be repeated as scheduled by the control unit 62.

In response to reaching block 120, the control unit 62 estimates the costs associated with operating the vehicle 100 in the GEN mode (see block 140). For example, the fuel costs may be calculated by multiplying the total fuel consumption by the fuel billing rate entered at block 108. The cost of energy consumption may similarly be calculated by multiplying the total energy consumption by the energy consumption billing rate. Finally, the total cost of run time can be calculated by multiplying the total run time by the run time billing rate.

These costs may be itemized and/or totaled and then displayed on the driver interface 60 at block 142 to provide the driver, operator, owner, etc. with an estimation of the costs of powering the vehicle 100 in the GEN mode. The costs could alternatively be communicated to a user's smartphone or other device within the scope of this disclosure, such as via the SYNC system manufactured by THE FORD MOTOR COMPANY.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method, comprising:
controlling a vehicle in a Power Generation mode to supply power to equipment separate from the vehicle, the controlling step including estimating a cost of operating the vehicle in the Power Generation mode.

2. The method as recited in claim 1, wherein the vehicle is a hybrid electric vehicle (HEV).

3. The method as recited in claim 1, wherein the controlling step is only performed if the vehicle is in park.

4. The method as recited in claim 1, wherein the controlling step includes at least controlling an engine and an electric machine to generate the power supplied during the Power Generation mode.

5. The method as recited in claim 1, comprising entering at least one billing rate associated with operating the vehicle.

6. The method as recited in claim 5, wherein the cost is estimated using the at least one billing rate.

7. The method as recited in claim 1, comprising entering energy usage limits for limiting a total amount of energy consumed during the Power Generation mode.

8. The method as recited in claim 1, comprising performing a series of periodic system checks to monitor a total energy usage of the vehicle during the GEN mode.

9. The method as recited in claim 1, comprising shutting down the Power Generation mode in response to at least one of the following occurring:
exceeding a fuel consumption limit;
exceeding an energy consumption limit; or
exceeding a time usage limit

10. The method as recited in claim 1, comprising displaying the costs associated with operating the vehicle in the Power Generation mode to an operator.

11. A vehicle control method, comprising:
operating a vehicle in a Power Generation mode;
supplying power to a power point of the vehicle during the Power Generation mode; and
estimating a cost associated with operating the vehicle in the Power Generation mode.

12. The method as recited in claim 11, comprising periodically measuring fuel consumption, energy consumption, and time usage during the step of operating.

13. The method as recited in claim 11, wherein the step of estimating includes at least one of the following:
multiplying a total consumption by a fuel billing rate;
multiplying total energy consumption by an energy billing rate; or
multiplying total run time by a time billing rate.

14. The method as recited in claim 11, comprising displaying the cost information to an operator of the vehicle.

15. A system, comprising:
a driver interface that provides selection of various vehicle operating modes including a Power Generation mode; and
a control unit in communication with said driver interface and configured to estimate a cost associated with operating said vehicle in said Power Generation mode.

16. The system as recited in claim 15, wherein said driver interface includes a mode selector having a Power Generation mode button for selecting said Power Generation mode.

17. The system as recited in claim 15, comprising a sensor configured to measure voltage and current information associated with powering said vehicle in said Power Generation mode.

18. The system as recited in claim 15, comprising a converter configured to convert DC power from an electric machine to AC power supplied to a power point located on said vehicle.

19. The system as recited in claim 18, wherein said power point includes at least one power outlet.

20. The system as recited in claim 15, wherein said control unit is operable to communicate control signals to each of an engine, a battery and an electric machine for operating said vehicle in said Power Generation mode.
